(19) United States
(12) Patent Application Publication
(10) Pub. No.: US 2021/0113411 A1
(43) Pub. Date: Apr. 22, 2021

(54) Platform Stabilisation System and Method

(71) Applicant: IQInvestments Corporation Pty Ltd, Wollongong (AU)

(72) Inventor: Geoffrey Redmond, Cronulla (AU)

(21) Appl. No.: 17/254,383

(22) PCT Filed: Jun. 21, 2019
(86) PCT No.: PCT/AU2019/050639

§ 371 Date: Dec. 21, 2020

(30) Foreign Application Priority Data
Jun. 22, 2018 (AU) 2018902242

(51) Int. Cl. A61H 1/00

(52) U.S. Cl. CPC A61H 1/005; A61H 1/001; A61H 2201/0142; A61H 2203/0425; A61H 2201/1215; A61H 2201/1661; A61H 2203/0406; A61H 2203/0456

(57) ABSTRACT

In an exercise system including a platform designed to undergo an inclined or declined precession like movement relative to a ground base, a method of limiting the translational movement of the platform and increasing its general stability, the method including the step of: (a) providing at least one slot and corresponding knob, with the inclined movement of the platform causing the movement of the knob along the slot. The system is particularly suited to bed treatment arrangements.

### FIELD OF THE INVENTION

The present invention relates to a platform exercise apparatus on which a user is standing, sitting or lying and wherein the platform undergoes inclined fixed translational radial motion so as to stimulate the vestibular of the brain, which in turn either consciously or subconsciously stimulates the neuromuscular skeletal system of the user.

### BACKGROUND OF THE INVENTION

Any discussion of the background art throughout the specification should in no way be considered as an admission that such art is widely known or forms part of common general knowledge in the field.

Exercise equipment devices where a user stands on a platform and undergoes a series of movements are known. For example, recently, PCT Application No. PCT/AU2017/050197 entitled “Muscle activation assembly system and method”, (the contents of which are hereby incorporated by cross reference) discloses an exercise device where the user stands on an inclined platform and undergoes a fixed transitional motion inclining and declining on a central axis. The user's brain is thereby stimulated both consciously and subconsciously into activating the neuromuscular skeletal system. The device is particularly useful in treating people with limited mobility but also finds general application in stimulating neuromuscular responses causing strengthening and healing

The foregoing described arrangement has a number of disadvantages. These can include having limited ability to deal with large structural forces generated by intensive or heavy use by heavy subjects. This is especially the case where the centrally located universal joint takes most of the stress associated with operation.

It would be desirable to provide for an alternative form of exercise apparatus.

### SUMMARY OF THE INVENTION

The present invention provides for an improved form of platform type exercise apparatus.

In accordance with a first aspect of the present invention, there is provided, in an exercise system including a platform designed to undergo an inclined precession like movement relative to a ground base, a method of limiting the translational movement of the platform and increasing its general stability, the method including the step of: (a) providing at least one slot and corresponding knob, with the inclined (or declined) movement of the platform causing the movement of the knob along the slot.

In some embodiments, the circumferential edge of the platform's low gravity point moves in a radial motion at 360 degrees. In some embodiments, the slot can be mounted on the ground base and the knob can be mounted on the platform. The knob can be mounted on an arm extending from an outer perimeter of the platform. The slot can be formed on the ground base. The platform can be generally circular.

In some embodiments there are preferably at least two slots on opposed sides of the platform. The inclination of the platform can be controlled by a worm screw between the platform and ground base. The platform can be connected to the ground base by means of a ball joint.

In accordance with a further aspect of the present invention, there is provided a platform exercise movement system including: a first base platform; a second platform adapted to undergo inclined movement whilst a user is placed upon the second platform; and a translational stability unit coupling the first base platform to the second platform and allowing movement relative thereto, the translational stability unit including at least one slot and corresponding knob, with the inclined movement of the platform causing the movement of the knob along the slot.

In some embodiments the platform can be a platform for a user to stand on. In other embodiments, the platform can form the base of a flat bed for a user to lie on. In other embodiments, the platform can form part of a bed.

In accordance with a further aspect of the present invention, there is provided, a platform exercise movement system including: a first base platform; a second platform adapted to undergo inclined and declined movement relative to the first base platform; a coupling system coupling the first base platform to the second platform and allowing relative movement between the platforms; and a bed type arrangement, formed on the second base platform to allow a user lying on the bed arrangement to undergo coupled movement in relation thereto.

Preferably, the system further includes a translational stability unit coupling the first base platform to the second platform and allowing movement relative thereto, the translational stability unit including at least one slot and corresponding knob, with the inclined or declined movement of the platform causing the movement of the knob along the slot.

Preferably, the system, further includes a roll cage type arrangement surrounding the bed and coupled to the second platform for providing user support in mounting the bed.

### BRIEF DESCRIPTION OF THE DRAWINGS

A description of the embodiments will now be described with reference to the accompanying drawings in which:

FIG. 1 illustrates a side plan view of an embodiment;

FIG. 2 illustrates a top plan view of an embodiment;

FIG. 3 illustrates a base portion of an embodiment in exploded form;

FIG. 4 illustrates a base portion of FIG. 3 in an assembled form;

FIG. 5 illustrates the addition of motor drive units to the base plate in an exploded form;

FIG. 6 illustrates a top perspective view of an assembled form of FIG. 5;

FIG. 7 illustrates an exploded perspective with the addition of a rotation plate to the base;

FIG. 8 illustrates a top perspective view of FIG. 7 in an assembled form;

FIG. 9 illustrates an exploded perspective with the addition of a platform and worm drive to the base unit;

FIG. 10 is a side plan view of the platform in an inclined position;

FIG. 11 is a side plan view of the platform in a flat position;

FIG. 12 illustrates the sectional view through the line A-A dashed of FIG. 11

FIG. 13 illustrates an exploded perspective with the addition of a cover plate around the platform;

FIG. 14 illustrates a top side perspective view with the assembled cover plate;

FIG. 15 illustrates a photograph of a bed arrangement mounted on the platform of the earlier arrangement;

FIG. 16 illustrates a further photograph of a modified bed arrangement mounted on the platform of the earlier arrangement, including a roll cage; and

FIG. 17 illustrates a further photograph of the arrangement of FIG. 16.

### DESCRIPTION OF PREFERRED AND OTHER EMBODIMENTS

In the preferred embodiments, there is provided a platform exercise apparatus that is similar to that described in the aforementioned PCT application but provides for a number of significant advantages to provide for an improved overall device.

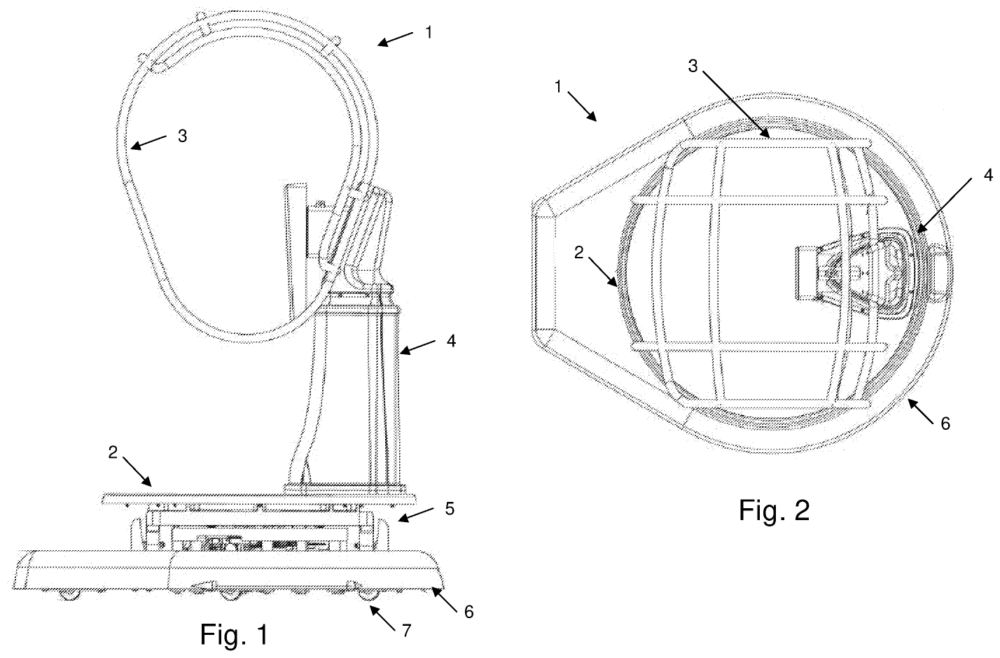

Turning initially to FIG. 1, there is illustrated a side plan view of a first embodiment 1 which comprises an exercise device where a user stands on a platform 2 and holds on to a cage structure 3 which is attached to a column 4. The platform and cage structure 2, 3 are fixed together and undergo synchronised movement and tilting so as to thereby engage the neuromuscular skeletal system of the user. The inclination and orientation of the platform 2 is controlled by an inclination control unit 5 which is mounted in turn on a base 6. The base 6 can in turn be mounted on a series of rollers eg. 7 for movement before fixing in place. The embodiment 1 achieves a similar functionality to that described in the aforementioned PCT application.

Turning now to FIG. 2, there is illustrated a top plan view of the exercise device 1, showing the platform 2, cage 3, column 4 and base 6.

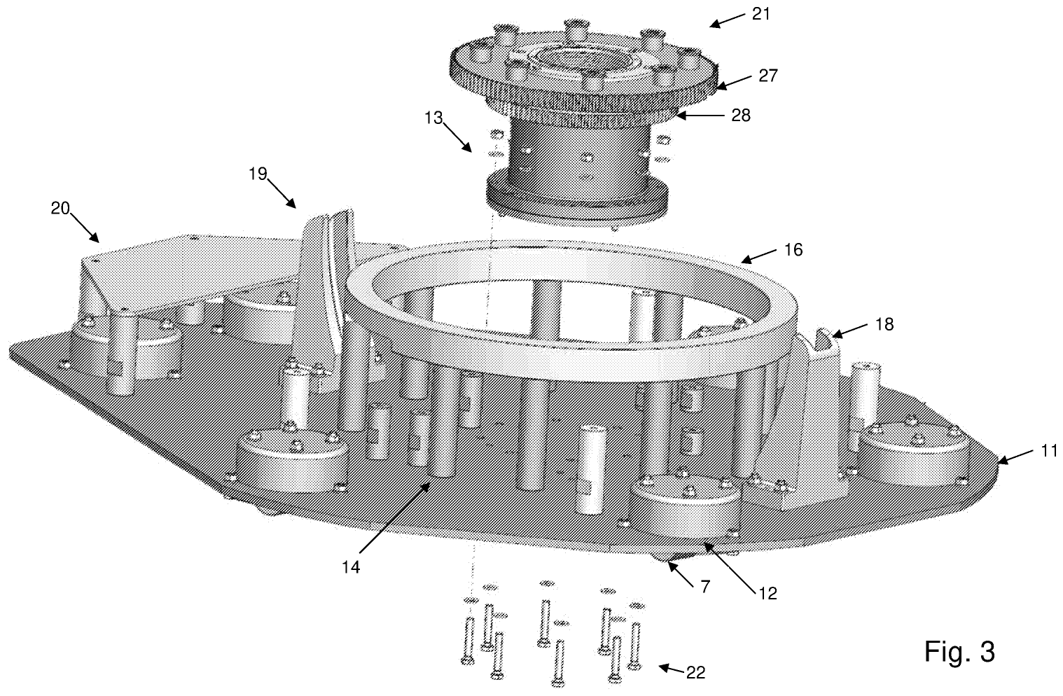

Turning now to FIG. 3, there is illustrated initial portions of the inclination control unit and base in exploded perspective. The inclination control unit is mounted on a base plate 11 which also includes a series of roller housings eg. 12 which mount rollers eg. 7.

On the base plate 11 also are mounted a series of posts e.g. 14 on top of which a ring 16 is mounted. Two slotted guides 18, 19 are provided on opposed sides of the ring 16. A further platform 20 is also provided.

A drive unit 21 is centrally mounted to the plate 11 via means of screws 22 which are mated with bolts 23. The drive unit includes a first mounted cogged ring 27 for driving a series of bearing rollers and a second mounted cogged ring 28 for driving a worm drive.

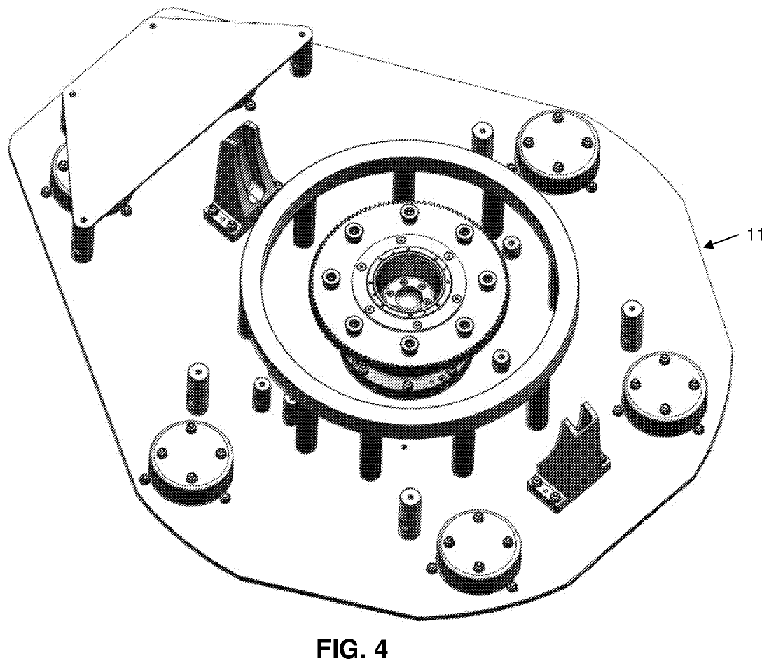

FIG. 4 illustrates a top perspective view of the arrangement of FIG. 3 in an assembled form.

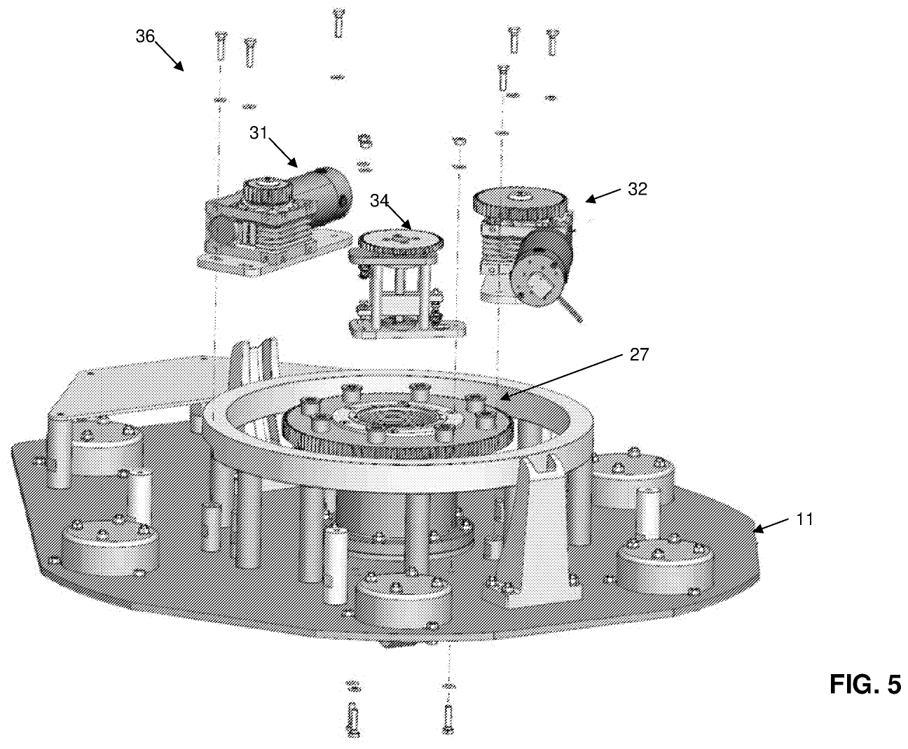

Turning now to FIG. 5, next a series of drive motors eg. 31, 32 are added to the plate 11. The drive motor 31 is utilised to drive the cogged ring 27 and the drive motor 32 is utilised to drive the worm drive cogged ring (28 of FIG. 3).

A stabilisation motion incline/decline limiting system 34 is also provided. The drive motors 31, 32 are affixed to the plate 11 by means of screws eg. 36.

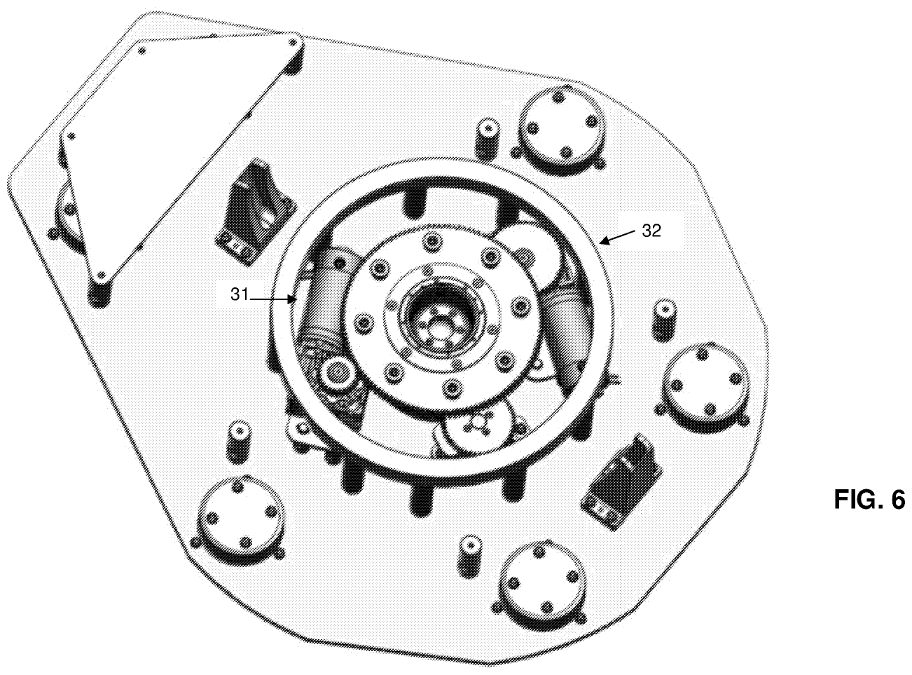

Turning to FIG. 6, there is illustrated the drive motors 31, 32 attached in an assembled form. The two drive motors are driven under electrical control in both a clockwise and anticlockwise direction.

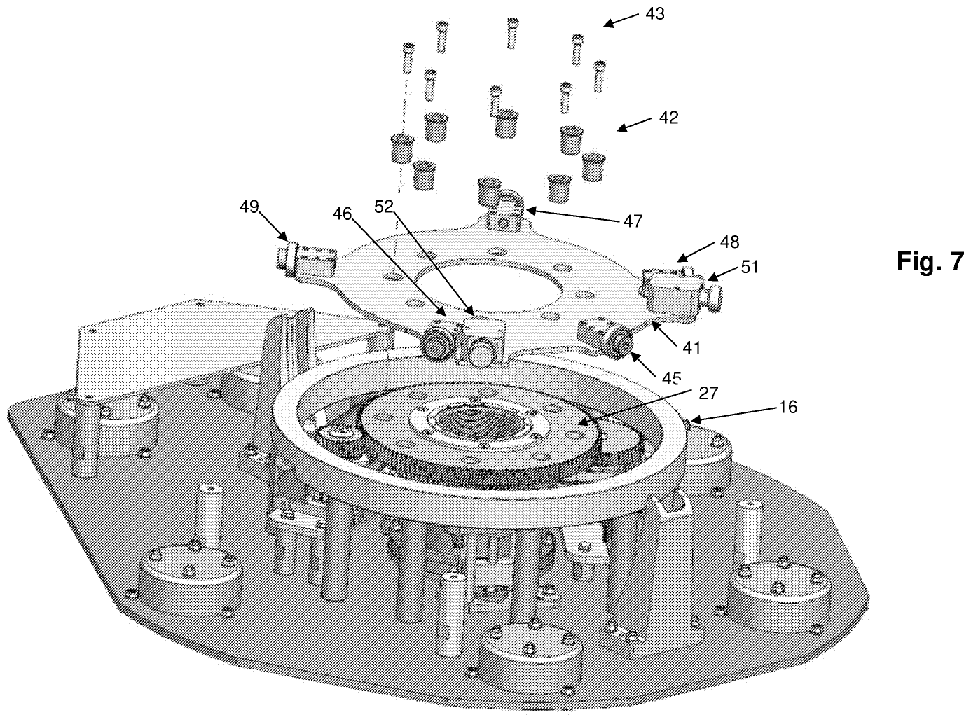

Turning now to FIG. 7, there is illustrated the addition of a rotation plate 41 which is mounted on the cogged ring 27 by means of washers 42 and screws 43. The drive 41 is designed to rotate with roller bearings 45-49 being designed to run around the top surface of ring 16. The rotation plate 41 is driven by cogged ring 27. The drive plate further includes two platform bearings 51, 52 which are designed to engage with a platform described hereinafter.

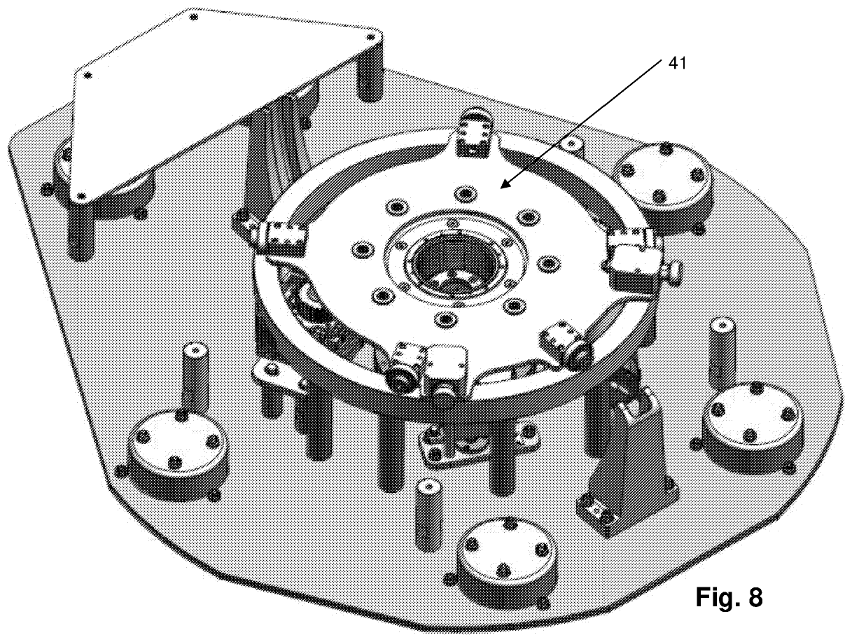

Turning to FIG. 8, there is illustrated the assembled form including the drive plate 41.

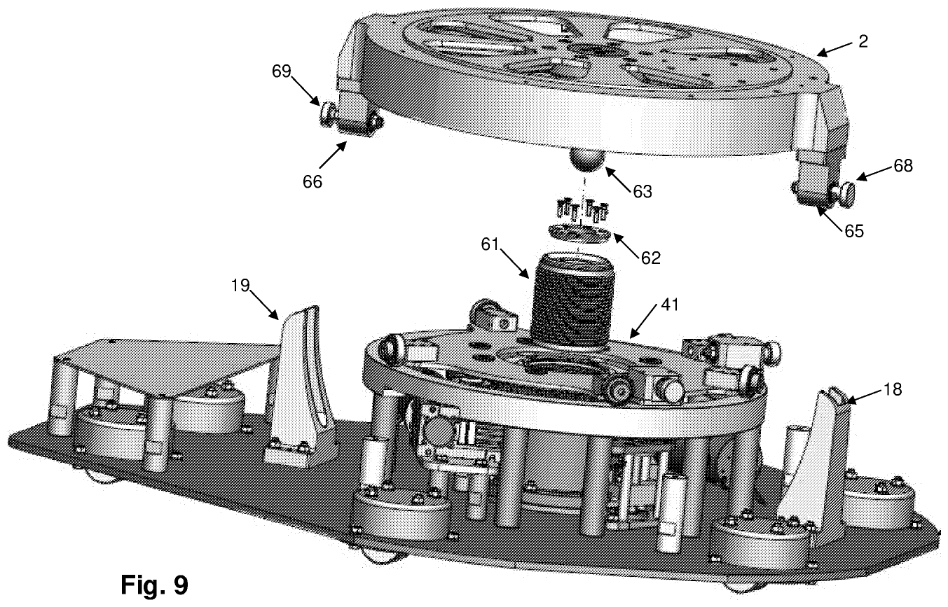

Turning now to FIG. 9, there is illustrated the attachment of the platform 2 to the base. The platform 2 includes a ball joint 63 on the base thereof which engages with ball joint receptor base 62 which is in turn attached to worm screw 61 which can be raised and lowered via means of a corresponding electric motor.

The platform 2 includes two arms 65, 66 each having a knob 68, 69 which engages with a slot in the corresponding slotted guides 18, 19 when assembled. In operation, the worm screw 61 is raised and lowered to set the angle of inclination of the platform 2 and the drive plate 41 is rotated so that the angle of inclination also moves with the slotted guides acting to control the position of arms 65, 66 which rise and fall as the platform 2 precesess around a central axis.

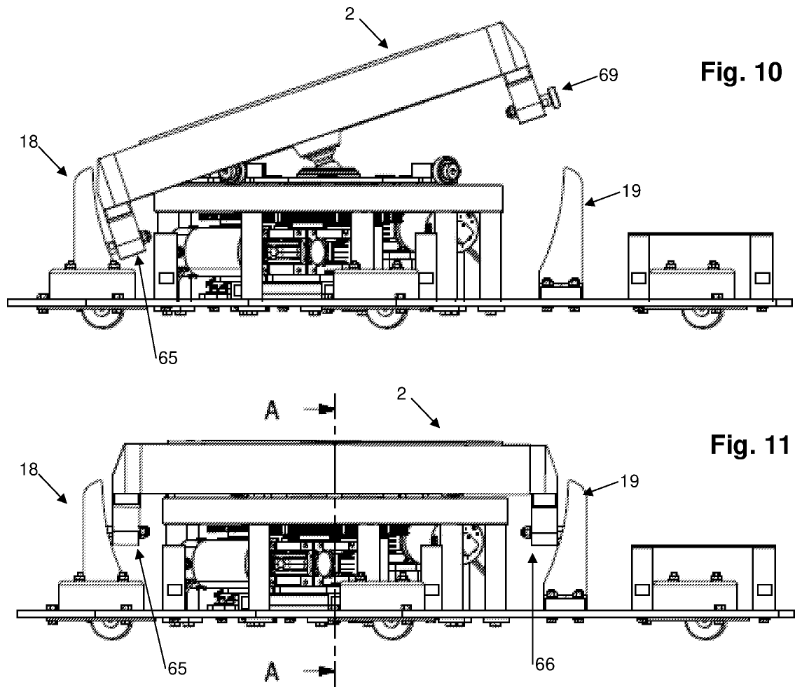

For example, FIG. 10 illustrates a side plan view of the platform when the worm screw is activated into a raised position, with the platform 2 inclined, the arm 65 engaged with the slotted guide 18.

FIG. 11 illustrates a side plan view when the worm screw is deactivated, with the platform horizontal and the arms 65, 66 including knobs engaged in corresponding slotted guides 18, 19.

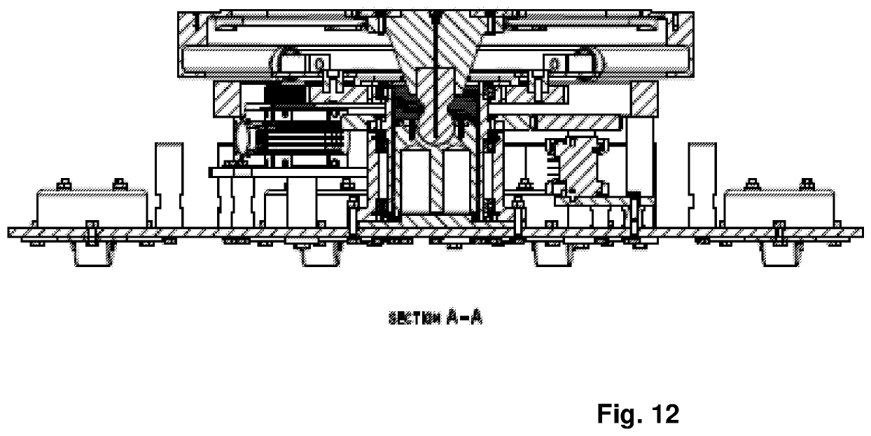

FIG. 12 illustrates a sectional view through the line A-A dashed of FIG. 11.

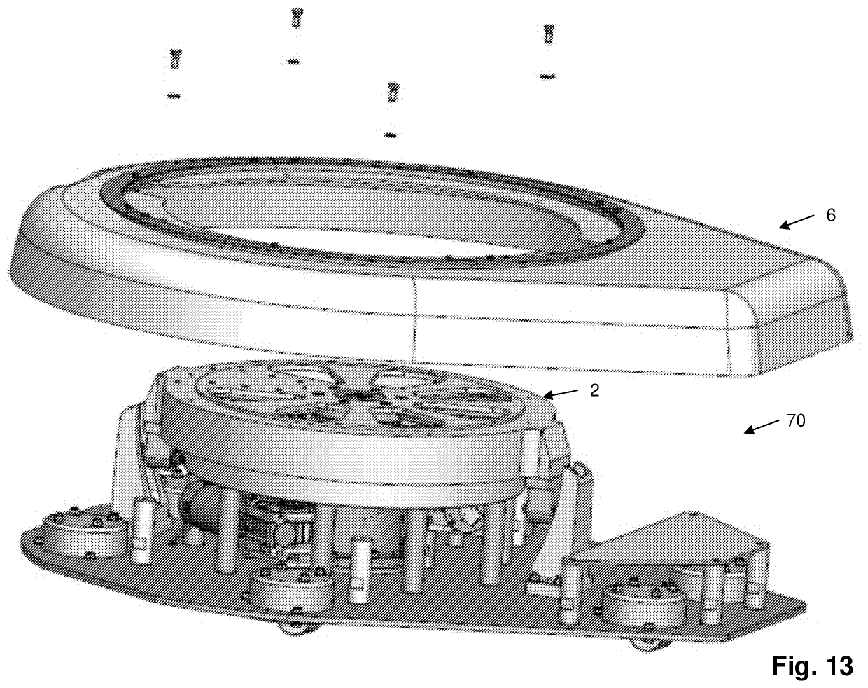

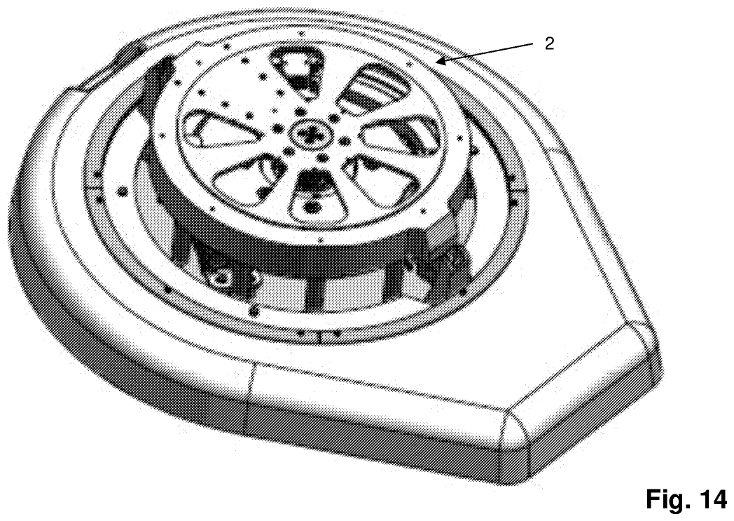

Turning now to FIG. 13, next a cover plate 6 is formed over the unit 70. FIG. 14 showing it in an assembled form. Subsequently, a base layer and cage is attached to the plate 2.

The arrangement described has the advantages that the slotted guides 18, 19 act to firmly guide the corresponding knobs so as to provide for a stable arrangement of the platform 2 whilst it is inclined or declined and the fixed transitional motion plate is activated so that the inclination precesses so that the user's head goes through a circumference around a central axis.

In this manner, the embodiment is able to be utilised in a more intensive manner than the previous arrangement with the slotted guides acting to reduce the amount of play in the fixed transitional motion plate and platform.

The arrangement allows for heavier loads to be utilised without significant distortion of the operation of the platform. This is particularly advantageous in a bed arrangement.

Further, the fixed transitional motion plate and platform can take many different forms. For example, instead of a platform that the user stands on, the platform can be formed as part of a bed, for a user to lie on. This is particularly advantageous when treating incapacitated or seriously ill patients, and providing neuromuscular stimulation and exercises thereto.

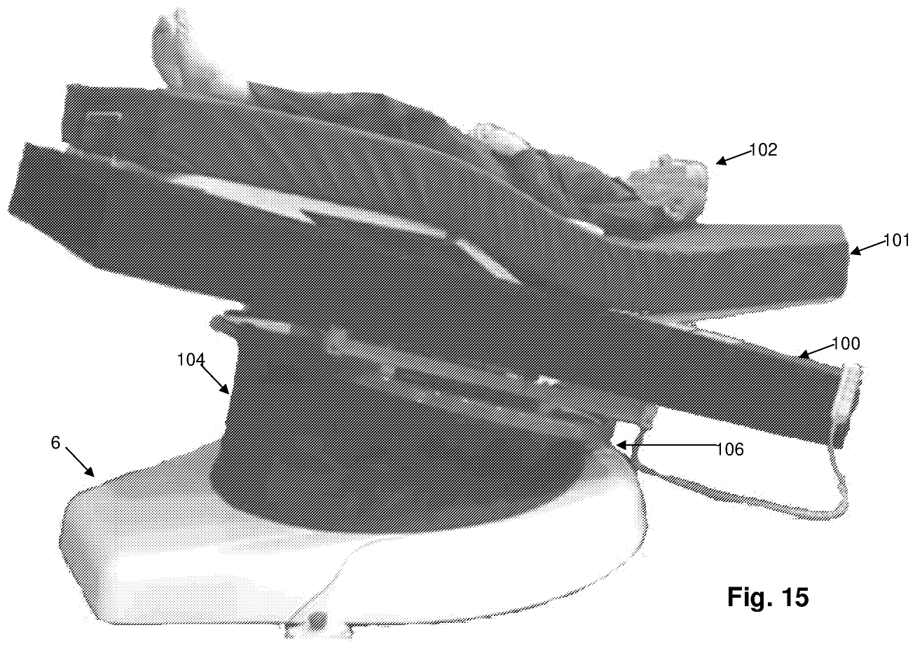

For example, FIG. 15 illustrates a photograph of a modified form of the system in order to handle a bed and patient. In this arrangement, a patient 102 is placed on a mattress 101, which is in turn placed on a base 100. The base 100 can be formed on the previous platform 106 which acts for overall control of the inclination and precession of the arrangement. The platform 106 can be the same as the base 2 of FIG. 1. A shroud 104 covers the internal portions 5 of FIG. 1, and the base 6 can be the same as base 6 of FIG. 1. In this way the arrangement can be suitably adapted to include an inclined patient.

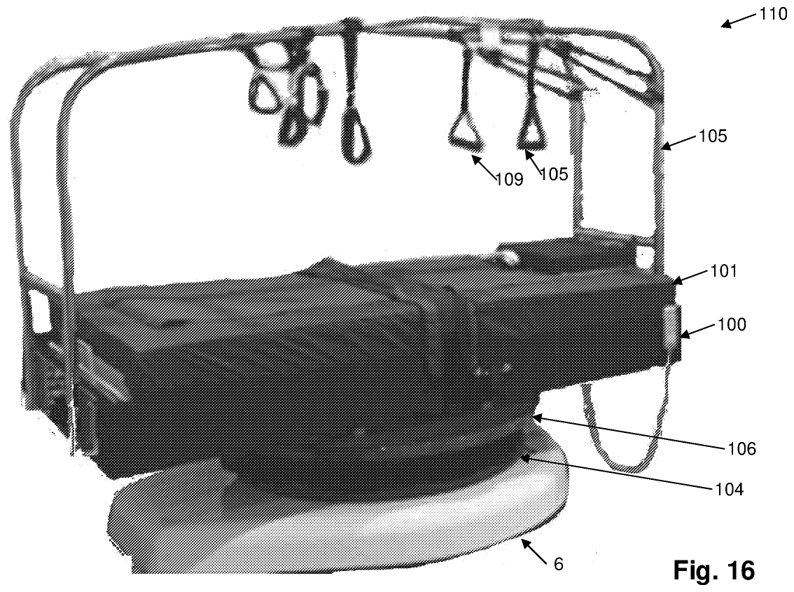

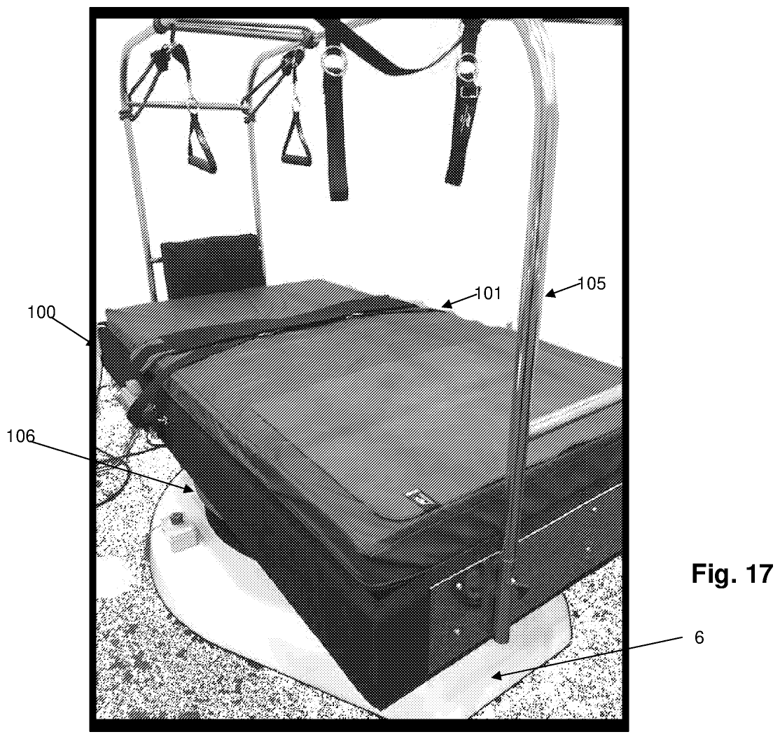

Other arrangements are possible. For example, FIG. 16 and FIG. 17 illustrate photos of a modified bed arrangement 110, which is modified to include a roll cage 105 for assisting in allowing patients to be placed on the bed 101. The roll cage including a series of clasps 109, 110, for allowing patients to enter and exit the bed arrangements between treatments.

In this manner the system of the embodiments can be extended to a bed arrangement for treatment of more incapacitated patients, in a similar manner to treatment of standing patients.

### Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. In an exercise system including a platform designed to undergo an inclined (or declined) precession like movement relative to a ground base, a method of limiting the translational movement of the platform and increasing its general stability, the method including the step of:
(a) providing at least one slot and corresponding knob, with the inclined (or declined) movement of the platform causing the movement of the knob along the slot.

2. The method as claimed in claim 1, wherein the slot is mounted on the ground base and the knob is mounted on the platform.

3. The method as claimed in claim 2, wherein the knob is mounted on an arm extending from an outer perimeter of the platform.

4. The method as claimed in claim 3, wherein the slot is formed on the ground base.

5. The method as claimed in claim 1, wherein the platform is generally circular.

6. The method as claimed in claim 1, wherein there is at least one slot on the platform.

7. The method as claimed in claim 1, wherein the inclination of the platform is controlled by a worm screw between the platform and ground base.

8. The method as claimed in claim 1, wherein the platform is connected to the ground base by means of a ball joint.

9. The method as claimed in claim 1, wherein said platform comprises a bed for a user to lie on and be treated by way of the application of the platform precessing in a fixed transitional motion inclining and declining around a fixed central point.

10. The method as claimed in claim 1, wherein the circumferential edge of the platform's low gravity point moves in a radial motion through 360 degrees.

11. A platform exercise movement system including:
a first base platform;
a second platform adapted to undergo inclined and declined movement whilst a user is placed upon the second platform; and
a translational stability unit coupling the first base platform to the second platform and allowing movement relative thereto, the translational stability unit including at least one slot and corresponding knob, with the inclined or declined movement of the platform causing the movement of the knob along the slot.

12. The system as claimed in claim 11, wherein the slot is mounted on the first base platform and the knob is mounted on the second platform.

13. The system as claimed in claim 12, wherein the knob is mounted on an arm extending from an outer perimeter of the second platform.

14. The system as claimed in claim 11, further including a worm screw arrangement for raising and lower the angle of inclination of the second platform.

15. The system as claimed in claim 11, wherein said platform includes a bed for a user to lie on and be treated by way of the application of the platform precessing in a fixed transitional motion inclining and declining around a fixed central point.

16. A platform exercise movement system including:
a first base platform;
a second platform adapted to undergo inclined and declined movement relative to the first base platform;
a coupling system coupling the first base platform to the second platform and allowing relative movement between the platforms; and
a bed type arrangement, formed on the second base platform to allow for a user lying on the bed arrangement to undergo coupled movement in relation thereto.

17. The platform exercise movement system as claimed in claim 16 further including:
a translational stability unit coupling the first base platform to the second platform and allowing movement relative thereto, the translational stability unit including at least one slot and corresponding knob, with the inclined or declined movement of the platform causing the movement of the knob along the slot.

18. The platform exercise movement system as claimed in claim 16, further including a roll cage type arrangement surrounding the bed and coupled to the second platform for providing user support in mounting the bed.
